(19) United States
(12) Patent Application Publication
(10) Pub. No.: US 2024/0406671 A1
(43) Pub. Date: Dec. 5, 2024

(54) OPTIMIZED TECHNIQUES FOR MONITORING MASSIVE GEOGRAPHIC LOCATION-BASED TRIGGERS

(71) Applicant: APPLE INC., Cupertino, CA (US)

(72) Inventors: Raj S. Chaugule, Santa Clara, CA (US); Michael P. Dal Santo, San Francisco, CA (US); Nai Tao Cui, Santa Clara, CA (US); Divya Cherukupalli, San Francisco, CA (US)

(73) Assignee: APPLE INC., Cupertino, CA (US)

(21) Appl. No.: 18/653,740

(22) Filed: May 2, 2024

Related U.S. Application Data
(60) Provisional application No. 63/506,100, filed on Jun. 4, 2023.

(51) Int. Cl. H04W 4/021; H04W 24/08; H04W 64/00

(52) U.S. Cl. CPC H04W 4/021; H04W 24/08; H04W 64/00

(57) ABSTRACT

A mobile device may install and monitor geofences. The application or the operating system (OS) may store a set of geofences. The application or OS may determine the mobile device's current location and generate a first bounding area around the current location. The application or OS may determine the size or radius of the first bounding area such that no more than a specified number of geofences fall inside the first bounding area. The application or OS may monitor the mobile device's location in the first bounding area and determine whether the mobile device exits the first bounding area. In response to determining that the mobile device exits the first bounding area, the application or OS may determine the mobile device's location and generate a second bonding area such that no more than the specified number of the geofences fall inside the second bounding area.

### CROSS-REFERENCES TO OTHER APPLICATIONS

This application claims priority to U.S. Provisional Application No. 63/506,100, for “OPTIMIZED TECHNIQUES FOR MONITORING MASSIVE GEOGRAPHIC LOCATION-BASED TRIGGERS” filed on Jun. 4, 2023, which is herein incorporated by reference in its entirety for all purposes.

### BACKGROUND

A geofence may be a virtual perimeter for a physical geographic area. The use of geofence may be called geofencing. Mobile devices (e.g., smartphones) may store several geofences and perform various location-based services as the user, e.g., the mobile device, enters or exits a geofence. Managing, monitoring, and tracking geofences and triggering associated actions may consume system processing and energy resources.

### BRIEF SUMMARY

According to various embodiments, a mobile device, e.g., an application or the operating system of the mobile device, may store and monitor one or more geofences. Geofences allow for an application to trigger an action when a user (mobile device) is near a specified location. Problems can arise when an application uses many geofences, e.g., due to computational effort to track whether a mobile device crosses a geofence. Due to such problems, operating systems generally limit the number of geofences that an application can use.

According to some embodiments, the application or OS may reduce the number of geofences that the application or OS monitors. In one embodiment, the application or OS may reduce the total number of installed geofences by detecting duplicates and combining them. In another embodiment, the application or OS may limit the number of to-be-monitored geofences by tiling schemes (e.g., using geohashing) to geofences in proximity to the user device. In another embodiment, the application or OS may further limit the number of monitored geofences to geofences that fall inside a bounding area.

In one embodiment, the application or OS on a mobile device may store a set of geofences. The application or OS may determine the current location of the mobile device and generate a first bounding area around the current location of the mobile device such that the number of geofences from the stored set geofences included in the bounding area does not exceed a specified number. The application or OS may monitor whether the mobile device exits the first bounding area. When the application or OS determines that the mobile device exits the first bounding area and in response to such determination, the application or OS may obtain the new location of the mobile device and generate a second bounding area around the new location of the mobile device such that the number of geofences from the stored set of geofences included in the bounding area does not exceed the specified number.

These and other embodiments of the disclosure are described in detail below. For example, other embodiments are directed to systems, devices, and computer-readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 illustrates a system environment 100 with multiple geofences in accordance with some embodiments.

FIG. 2 illustrates a method for monitoring geofences in accordance with some embodiments.

FIG. 3 illustrates examples of geofence duplication detection in accordance with some embodiments.

FIG. 4 illustrates a method for implementing geofence duplication detection flow in accordance with some embodiments.

FIG. 5 illustrates a block diagram of hash filtering in accordance with some embodiments.

FIG. 6 illustrates a method for implementing map tile filtering flow in accordance with some embodiments.

FIG. 7 illustrates a block diagram of bounding area modes in accordance with some embodiments.

FIG. 8 illustrates a block diagram for determining the distance between a user device and a geofence.

FIG. 9 illustrates a method for implementing a bounding area in accordance with some embodiments.

FIG. 10 illustrates a method for implementing a bounding area in accordance with some embodiments.

FIG. 11 is a block diagram of an example device according to embodiments of the present disclosure.

### DETAILED DESCRIPTION

Some applications running on a mobile may provide location-based services (LBS) to the user. The application may create geofences around points of interest and monitor whether the user's geographical location is inside a geofence. Once the application detects the user's geographical location inside a geofence, it may initiate a geographical trigger. The geographical trigger may operate on the device and offer LBS to the user. For example, a wallet application may detect that the user is in the airport and notify the user to add their boarding pass to the wallet application.

The operating system (OS) or the application may implement geofencing. In the case of OS-level geofencing, the OS can monitor the device's location and trigger actions when the device enters or exits the predefined geographic area. In the case of application-level geofencing, the application can monitor the device's location and trigger actions based on geofencing rules defined within the application.

Geofencing may use the device's location services to determine its location. The location services may use a combination of technologies such as global positioning satellite (GPS), WiFi, ultra-wideband (UWB), Bluetooth, or cellular data to determine the device's location. When geofencing is enabled, the device may periodically send its location to the operating system or the application implementing the geofencing feature. The operating system or application then compares the device's location to the predefined geographic areas and triggers actions when the device enters or exits those areas. Examples of the action may include, but are not limited to, sending a notification to the user, launching an application, or sending data to a server.

A geofence may define the monitoring area by specifying a geographic location and a radius around that location. The location may be specified using coordinates, e.g., latitude and longitude, or by using an address or landmark. The radius of the geofence may determine the size of the area around the location that will be monitored. The geofencing feature may trigger an action when the device enters or exits the area defined by the location and radius. For example, the OS or the application may compute the distance between the device and the geographical location and determine the device is inside the geofence when the distance is smaller than the geofence radius.

To manage the allocation of system resources, such as the battery, memory, or processing cycles, the operating system on the device may limit the number of geofences that the OS or the application may track at any given time. System and application developers desire to provide location services to the user subject to the limited number of available geofences.

One solution may be to increase the radius or size of the geofence. Although increasing the size may reduce the number of geofences the OS or application may need to monitor, it may degrade the user experience. For example, the geofence may trigger an action when the user's device is far from the point of interest. Moreover, larger geofences may be harder to detect. For example, 72% of large geofences with a radius larger than 7000 m, 88% of medium geofences with a radius between 400 m and 7000 m, and 92% of fine geofences with a radius less than 400 m may be detected within 3 minutes.

In some instances, to reduce the impact of geofence monitoring on device resources, the device may provide the user's location to a remote application server, which, for example, may reside on the cloud. This solution may raise privacy concerns when reporting user location to external parties. In addition, exchanging locations with the remote server may require an internet connection and excessive signaling, which may negatively impact the availability of location services.

It is desired to increase the limitation on the number of concurrently programmed geofences without degrading the user experience, the availability of system resources, or compromising privacy.

### I. Overview

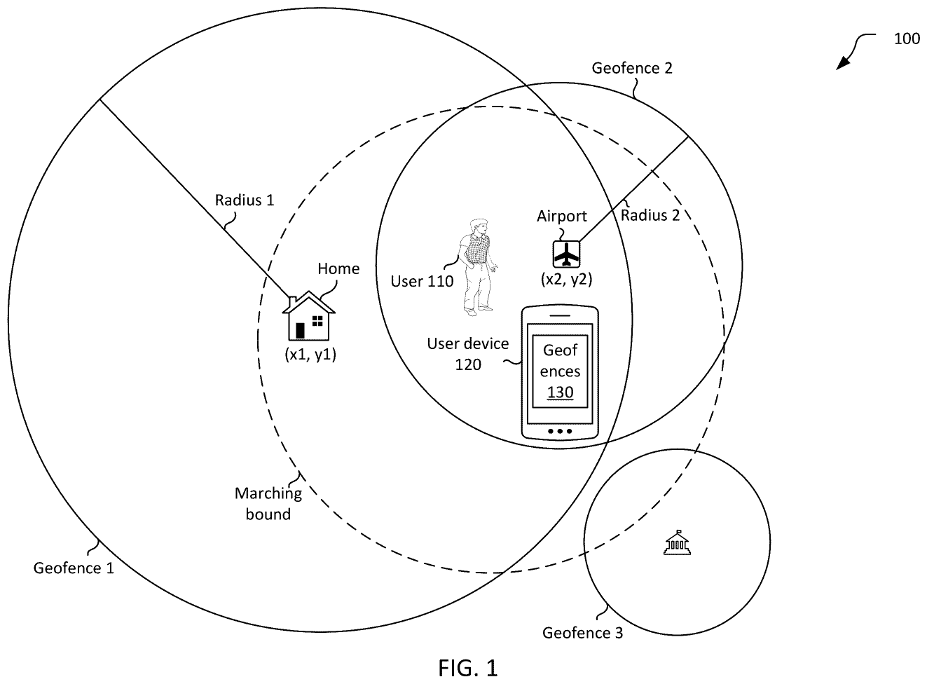

FIG. 1 illustrates a system environment 100 with multiple geofences in accordance with some embodiments. User 110 may carry user device 120. Several geofences 130 may be installed on user device 120. For example, geofence 1 for the home environment, geofence 2 for the airport, and geofence 3 related to other location-based services may be installed on user device 120. The home environment geofence 1 may have the coordinates (x1, y1) where x1 is the longitude and y1 is the latitude of the home. The size of geofence 1 is determined by its radius, Radius 1. Similarly, airport geofence 2 may have coordinates (x2, y2) where x2 is the longitude and y2 is the airport's latitude. The size of geofence 2 may be determined by its radius, Radius 2. User device 120 may be inside both geofence 1 and geofence 2, and the application or the OS may trigger the actions corresponding to each geofence. Geofence 3 may also be installed on user device 120. However, user device 120 may be outside geofence 3, so the application or OS has not triggered the action(s) associated with geofence 3. Various techniques can be used to manage the geofences.

For example, the OS or the application can detect geofence duplication. Geofence duplication may occur when at least A % of the area of one geofence overlaps with the area of another geofence. The application or OS may combine the duplicated geofences into one geofence. The application or OS may also combine the actions corresponding to the duplicated geofences and associate the combined actions to the combined geofence. For example, the application or OS may determine that at least A %, e.g., 50%, 60%, 70%, 80%, or 90% of geofence 2 is covered by geofence 1 and combine the two geofences and their corresponding actions into one geofence. The specified percentage value of A % may be defined by the application or OS.

In another example, the world is partitioned into standardized tiles associated with a specific identifier, such as a map tile index, e.g., a geohash. Based on user location, the application or OS may filter out any geofences not in the proximity of user 110, reducing the number of geofences that the application or OS may monitor simultaneously.

In yet another example, the application or OS may create a bounding area (also referred to as a bounding geofence) associated with the current location of user 110, e.g., having a bounding radius, although other shapes may be used. The application or OS may adjust the bounding radius to have a suitable number of installed geofences overlapping with the bounding area. Depending on the density of geofences, the application or OS may monitor bounding areas or overlapping geofences.

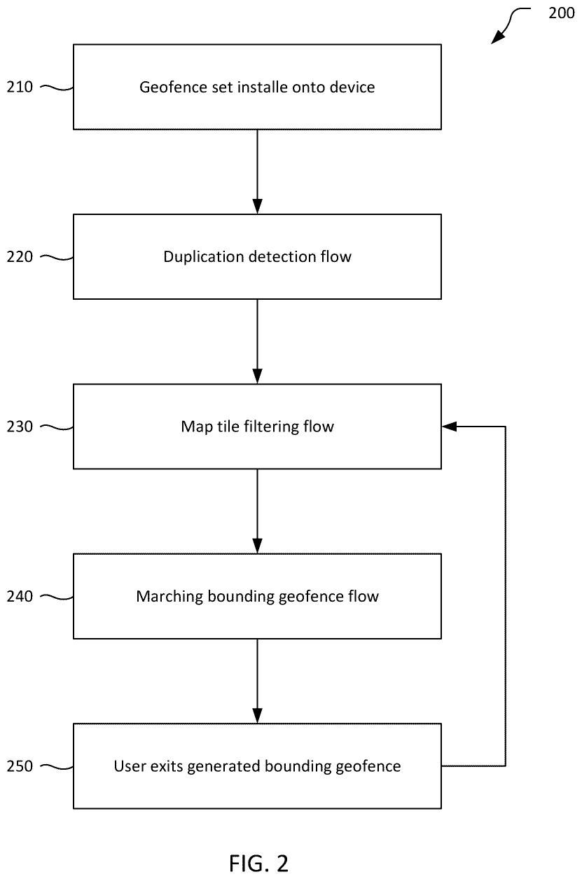

FIG. 2 illustrates method 200 for monitoring geofences in accordance with some embodiments. The operation flow/algorithmic structure 200 may be implemented by a mobile device, e.g., mobile device 1100, or the components therein, e.g., geofence module 1128, operating system 1122, or applications 1134.

At 210, method 200 may include registering geofence sets onto a device. The installation of geofences on the device may include storing them in memory, a storage device, e.g., local or added storage, or a file. In one example, an installed geofence may be associated with several parameters (e.g., coordinates and radius), attributes (e.g., importance or priority), or one or more actions.

At 220, method 200 may include performing duplication detection flow. Duplication detection flow, as described above, may combine two geofences into a new geofence when at least A %, e.g., A=80, of the area of one geofence, overlaps with the area of another geofence. In this manner, the number of geofences is reduced while not changing the overall result significantly, thereby saving computational effort.

At 230, method 200 may include performing map tile filtering (e.g., using geohashing) to reduce the number of geofences that are monitored. In this manner, the number of geofences that are monitored is reduced to map tiles in the proximity of the mobile device. The number of geofences is reduced while not changing the overall result or user experience, thereby saving computational effort.

At 240, method 200 may include performing marching bounding area flow in which the application or OS creates a bounding area based on the location of the user device, as described above. In areas with a high density of geofences, the application or OS may reduce computational complexity by monitoring mobile device location in a bounding area, e.g., only the geofences in the bounding area are monitored. The application or OS may select the size of the bounding area so that a limited number of geofences fall inside the bounding area.

At 250, method 200 may include detecting the user exiting the generated bounding area and repeating the process starting at 240, e.g., marching bounding area flow, or starting at 230, e.g., map tile filtering. The exit of the bounding area allows for a reevaluation, given the new position of the mobile device. In this manner, a new set of geofences can be identified using the map tile filtering, and potentially, a new set of geofences can be monitored with the bounding area.

The disclosed embodiments, separately or in combination, may enable monitoring of a large number of geofences on the device to avoid privacy issues or system performance degradation. Moreover, the ability to monitor a large number of geofences may allow defining smaller geofences without sacrificing accuracy.

### II. Geofence Duplication Detection

Geofence duplication detection flow may identify geofences with significant overlap and combine them into one. Geofence duplication detection flow, particularly in areas with a high density of geofences, may effectively reduce the number of monitored geofences. In this manner, the computation complexity is reduced without compromising performance or user experience.

### A. Geofence Duplication Detection

The device may monitor two geofences where a significant area of a first geofence overlaps with the area of a second geofence. Overlapping a substantial area of one geofence with the area of another may be called geofence duplication. The application or OS may determine that a substantial area of the first geofence overlaps with the area of the second geofence when at least A % of the area of the first geofence overlaps with the area of the second geofence. The value of A may be the application or OS parameter. In some instances, the value A may be fixed. In another instance, the value A may be dynamically set, e.g., based on system resources such as available battery or computation resources, user experience requirements, system operation requirements, or the number of installed geofences.

When the device detects a geofence duplication, the device, e.g., the application or the operating system, may adopt one of the following options to reduce the computation and improve the device's resource utility.

In the first option, the device, e.g., the application or OS, may drop monitoring the first geofence whose area is substantially overlaps with another geofence. The application or OS may combine the actions associated with the first geofence with the actions associated with the second geofence and only monitor the second geofence. When the user device is in a location that is inside the first geofence but outside the second geofence, the application may not trigger the action associated with the first geofence and create dark spots or blind spots for the first geofence. The miss detection in this option may be the tradeoff between user experience and complexities associated with monitoring the first geofence.

In a second option, the application or OS may combine the first and the second geofences into a third geofence. The application or OS may drop monitoring the first and the second geofence, form a third geofence based on the first and second geofences, and monitor the third geofence instead. The application or OS may also combine the actions associated with the first and second geofences and assign them to the combined third geofence.

The first and second geofences may be represented by a center coordinate and radius having a circular geometric shape. In one example, the third geofence may be formed as a convex hull or union of areas of the first and second geofences. In another example, the third geofence may be tangent to the first and second geofences and have a circular shape with its center on a line connecting the centers of the first and second geofences. A person skilled in the art may use geometry and proportional triangles to find the coordinates of the center and the length of the radius of the third geofence.

The second option may include locations inside the third geofence but outside the first and second geofences. When the user device is in such locations, the operating system or the application may trigger the actions associated with the first and second geofences, an event that wouldn't happen if the device was monitoring the first and second geofences. This false alarm triggering may be the tradeoff between user experience and complexities associated with monitoring the third geofence instead of the first and second geofences.

Alternatively, the third geofence may encompass the first and second geofences having a polygon geometric shape, e.g., a regular hexagonal shape. Monitoring a circular geofence may require less computational complexity than monitoring geofences having other geometric shapes.

### B. Examples of Geofence Duplication Detection

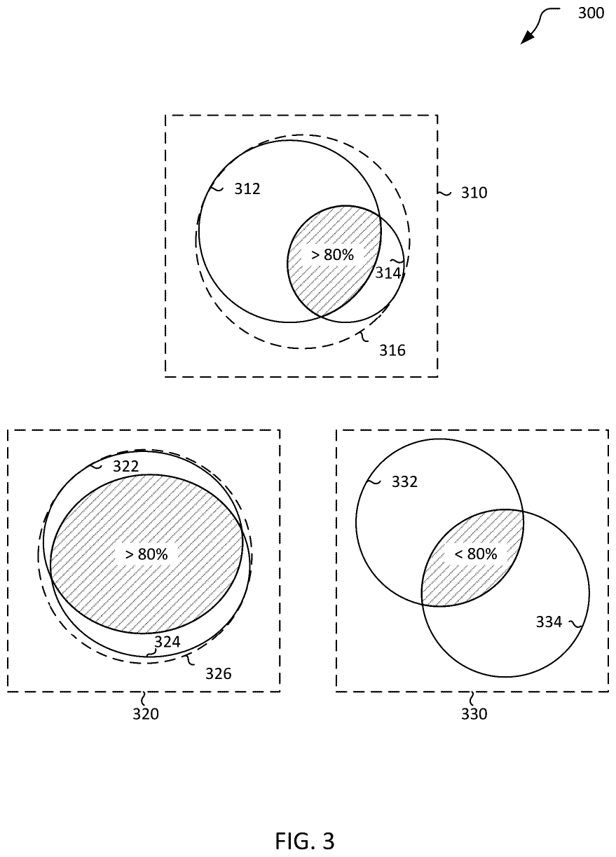

FIG. 3. illustrates examples of geofence duplication detection 300 in accordance with some embodiments. The overlapping threshold in this example is A=80, e.g., a duplication is detected when the area of one geofence has at least 80% overlap with another geofence.

In example 310, more than 80% of the area of geofence 314 overlaps with geofence 312. The application or OS may detect the geofence duplication and combine geofences 312 and 314 to form geofence 316. Geofence 316 may have a circular shape encompassing the area of geofences 312 and 314. In this example, only more than 80% of the area of geofence 314 overlaps with geofence 312, and less than 80% of the area of geofence 312 overlaps with geofence 314.

In example 320, more than 80% of the area of geofence 324 overlaps with geofence 322, and more than 80% of the area of geofence 322 overlaps with geofence 324. The application or OS may detect the geofence duplication and combine geofences 322 and 324 to form geofence 326. Geofence 326 may have a circular shape encompassing the area of geofences 322 and 324.

In example 330, more than 80% of the area of geofence 332 does not overlap with geofence 334. Similarly, more than 80% of the area of geofence 334 does not overlap with geofence 332. The application or OS may not detect the geofence duplication.

### C. Flowchart

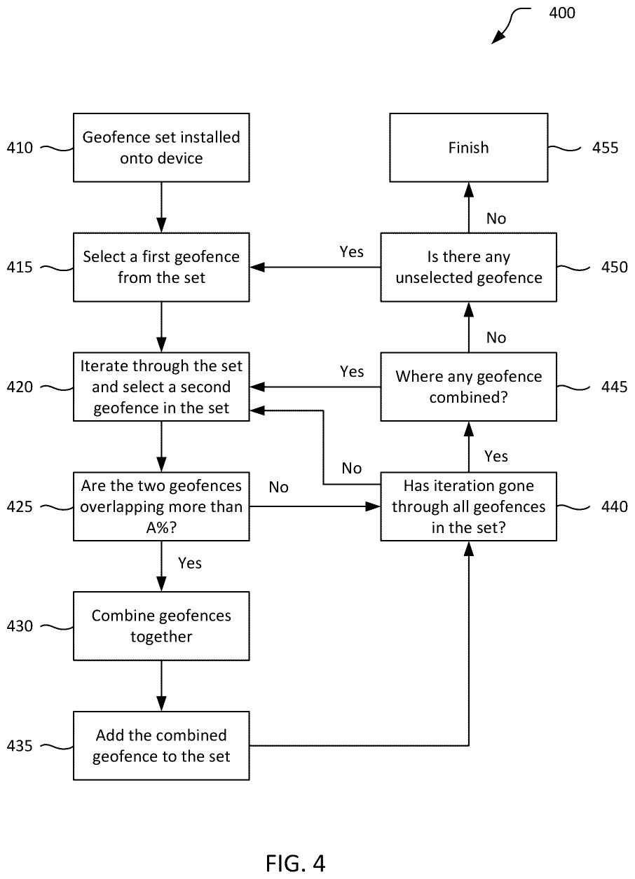

FIG. 4 illustrates method 400 for implementing geofence duplication detection flow in accordance with some embodiments. The operation flow/algorithmic structure 400 may be implemented by a mobile device, e.g., mobile device 1100, or the components therein, e.g., geofence module 1128, operating system 1122, or applications 1134.

At 410, method 400 may include installing a set of geofences onto the device. The application or operating system may install the geofences onto the user's mobile device. The installation may include storing parameters, e.g., coordinates and radius, and attributes associated with a geofence in the device.

At 415, method 400 may include selecting a first geofence from the set of geofences. In one example, a first iterator may be assigned to track the selection.

At 420, method 400 may include selecting a second geofence in the set. The algorithm compares all remaining geofences in the set of geofences with the first geofence selected at 415 by iterating through the set and selecting the geofences one by one. In one example, a second iterator may be assigned to track the selection.

At 425, method 400 may include determining whether at least the specific percentage of the area of the first geofence overlaps with the area of the second geofence or whether at least the specific area of the second geofence overlaps with the area of the first geofence. For example, at 410, the algorithm may determine whether 80% or more of the area of the first geofence overlaps with the area of the second geofence or whether 80% or more of the area of the second geofence overlaps with the area of the first geofence. With either determination, the algorithm advances to perform operations described at 430. Otherwise, the algorithm may advance to perform the operations described at 440.

At 430, method 400 may include combining the first and second geofences to form a third geofence. The third geofence may be circular and tangent to both the first and second geofences.

At 435, method 400 may include adding the third geofence to the set of geofences. The third geofence may replace the first and second geofences in the set of geofences. The application or OS may keep the first and second geofence information. The application or OS may monitor the third geofence instead of the first and second geofences. In some instances, the application or OS may resume monitoring the first or second geofences.

At 440, method 400 may include determining whether all the geofences in the set are compared against the first geofence. If there are other geofences remaining to be compared for the amount of overlap with the first geofence, the algorithm will follow the “No” path and repeat the operations described at 420-435. However, if all geofences in the set were compared against the first geofence for the amount of overlapping area, the algorithm follows the “Yes” path to perform the operation described at 445.

At 445, method 400 may include determining whether any geofences combined, e.g., because of the operation described at 430. If geofences were combined, the algorithm would follow the “Yes” path to perform the operation described at 420. However, if no geofences were combined, the algorithm would follow the “No” path to perform the operation described at 450.

At 450, method 400 may include determining whether all the geofences selected by the algorithm by the operation described at 415. For example, the algorithm may use the first iterator to check whether the iterator has selected all the geofences in the set. In response to the determination that there are unselected geofences, the algorithm would follow the “Yes” path to perform the operation described at 415. In response to the determination that there are not any unselected geofences, the algorithm would follow the “No” path to perform the operation at 455. The operational flow/algorithmic structure 400 may include, at 455, terminating the algorithm.

### III. Filtering Based on Map Tiles

The world may be partitioned into separate standardized tiles, and each tile may be associated with an index or an identifier. Based on user location, the application or OS may identify a subset of geofences in the tile on which the user is located and tiles in the vicinity of the user, e.g., neighboring tiles. The application or OS may monitor geofences in the identified subset, thus reducing the number of monitoring geofences. In this manner, the application or OS may reduce the computational complexity without compromising performance or user experience.

One example of map tiling is geohashing. Geohash may encode a geographic location into a short string of letters and digits. It may be a hierarchical spatial data structure subdividing space into grids or tiles and assigning a code to each grid or tile. Geohash may be shorter than a regular address or latitude and longitude coordinates and may be easier to store. Geohash may be used for proximity searches and to find nearby locations.

### A. Map Tile Filter Using Grid

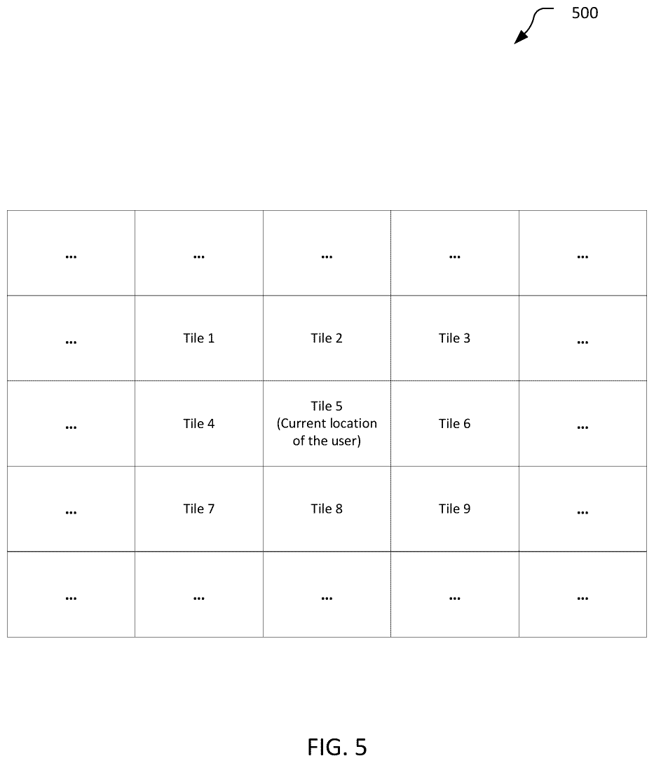

FIG. 5 illustrates a block diagram 500 of map tile filtering (e.g., using geohashes) in accordance with some embodiments. To reduce the number of geofences being monitored, the application and OS may only monitor the geofences close to the device's current location. However, the installed geofences are not associated with the device's current location. Therefore, the application or the OS may not determine which geofences are in its vicinity and which ones are far away. Using the tile index (e.g., geohashing) described here, the application or OS may reduce the number of geofences being monitored to only those close to the device.

The map tile filtering (e.g., geohashing) may separate the world into standardized tiles (or map tiles), and each tile may have an index and be associated with a specific map tile index (e.g., geohash). For example, FIG. 5 shows the user's current location at a tile associated with map tile index 5 (e.g., geohash 5), the eight immediate neighboring map tiles associated with map tile indices 1-4 and 6-9, and the extension of tiles in all directions.

The shape and size of each tile are configurable. For example, the size of a tile may depend on the number of indices or, in the case of geohashing, on the configuration of the geohash. For example, a four-digit geohash may support a 5 (Kilometer)×5 (Kilometer) square tile.

Each tile may include one or more geofences or potentially no geofences. Any geofence(s) in a tile may be associated with a tile index (e.g., a geohash) associated with that tile. For example, the application or OS may create a dictionary having a tile index (e.g., a geohash) as the key and a list of geofences in that tile as the value. The application or OS may use the coordinates of the geofence, e.g., the coordinates of the center of a circular geofence, to identify the tile index (e.g., geohash) associated with the location of the geofence.

The application or OS may use map tile filtering (e.g., geohashing) to determine which tile it is located, identify its neighboring tile, and limit the monitoring geofences only to those associated with the tile it is at and its eight neighboring tiles. For example, the application or OS may use the GPS coordinates of the user device to find out the tile and associated tile index (e.g., geohash) of the device's current location. The application or OS may use the current location and associated tile index (e.g., geohash) to find the eight neighboring tiles around the current location of the user device, e.g., by using a lookup table. Having the geofences associated with the current and neighboring tiles, the application or OS can limit geofence monitoring to only those geofences.

In one example implementation, the tiles may have R many rows and C many columns. A row can be identified with Log₁₀(R) many digits (round to the next integer). Similarly, Log₁₀(C) many digits (round to the next integer) can identify any column. The rows may indicate north to south direction starting with 0, at a known location, to R−1, and columns may indicate east to west direction starting with 0, at a known location, to C−1. A tile index can be created by concatenating a row index and a column index.

In one example, the geohash may be based on the public domain geocode system based on the Gustavo Niemeyer algorithm. Geohash, en.wikipedia.org/w/index.php?title=Geohash&oldid=1211820754.

For example, a 10×10 grid may use digits 0-9 to determine the row and 0-9 to determine the column of tile. If a mobile device is located at location 46, it can be interpreted that it is located in the fifth row and seventh column. The immediate neighboring tiles can easily be identified based on the indexing pattern. For example, tiles 45 and 47 may be to the east and west of the mobile device, tiles 36 and 56 to the north and south of the mobile device, and tiles 35, 37, 55, and 57 are at NE, NW, SE, and SW of the mobile device.

A lookup table may be used to find the tile of a location. For example, the rows of the table may be indexed by the range of longitude, the range of latitude may index the columns, and table entries may be the index of the tile. For example, a longitude between G1 and G2 is associated with row 1 of the table, and a longitude between G2 and G3 with row 2, and so on. Similarly, a latitude between L1 and L2 may be associated with column 1 of the table, and a latitude between L2 and L3 with column 3, and so on. A mobile device location with a longitude between G1 and G2 and a latitude between L2 and L3 may be associated with a tile whose index is stored in row 1 and column 2 of the table. The tile indices (e.g., geohash) may create a spatial relationship between a given tile and its neighbors.

The application may only use tiles and associate each geofence to a tile. The application or OS may then determine the tile the mobile device is located at and its neighboring tiles. Using the association between tiles and geofences, the application or OS may determine the geofences in its current tile and neighboring tiles and limit monitoring operation only to these geofences.

To expand the geographic area covered by tiles, the application or OS may increase the tiles' size or the number of tiles and reassign geofences to the tiles indices (e.g., geohash). Alternatively or additionally, the application or OS may increase the number of tiles whose geofences are being monitored. For example, instead of monitoring the current tile and the immediate neighbors, the application or OS may monitor the geofences in the current tile, the immediate neighbors, and the immediate neighbors of the immediate neighbors, e.g., two-hop neighbors in a 5-tile×5-tile grid.

Geohash can have a one-to-one association with a tile. Geohash may have a one-to-many association with geofences. For a specific geofence, the geofence's longitude and latitude may be mapped to a tile or a geohash. In some instances, multiple geofences may reside within the same tile or geohash. Geohash may allow the storage of multiple geofences using the same geohash as the dictionary. Each tile may have a static value, and a numbering pattern may allow the determination of its neighboring tiles from the tile's static value. In some instances, the geohash of any coordinate within a tile is the same. The geohash may be determined using the algorithm discussed above.

### B. Flowchart

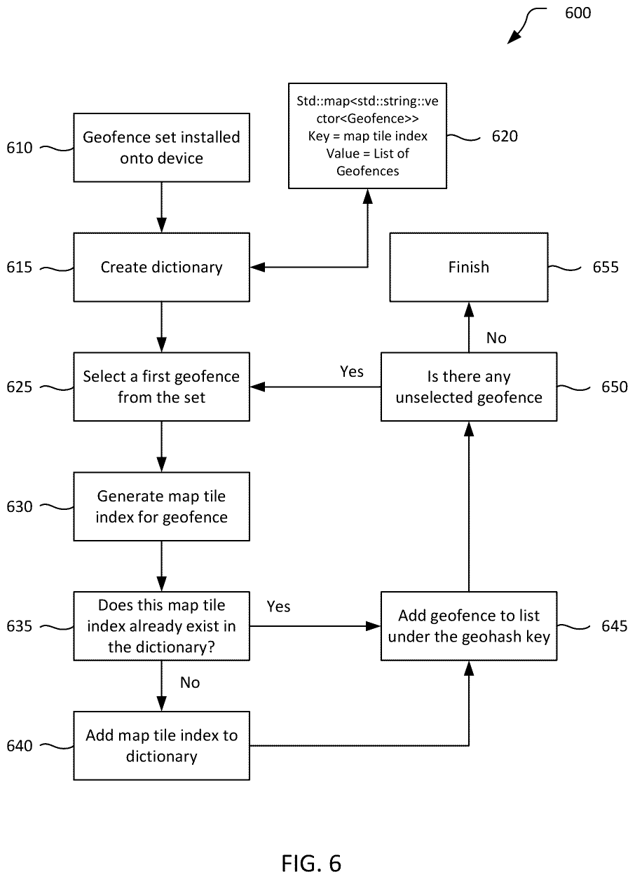

FIG. 6 illustrates method 600 for implementing map tile filtering (e.g., geohashing) flow in accordance with some embodiments. The operation flow/algorithmic structure 600 may be implemented by a mobile device, e.g., mobile device 1100, or the components therein, e.g., geofence module 1128, operating system 1122, or applications 1134.

At 610, method 600 may include installing a set of geofences onto the device. The application or operating system may install the geofences onto the user's mobile device. The installation may include storing parameters, e.g., coordinates and radius, and attributes associated with a geofence in the device. The geofence set may be updated by applying the geofence duplication detection flow described above.

At 615, method 600 may include creating a dictionary. For example, the algorithm may use the operation described at 620 to create the dictionary. The dictionary associates each geofence to a tile index (e.g., geohash) based on the physical location of the geofence and the physical or geographical area of the tile.

At 625, method 600 may include selecting a first geofence from the set of geofences. In one example, a first iterator may be assigned to track the selection.

At 630, method 600 may include generating a map tile index (e.g., geohash) for the geofence. For example, the application or OS may generate a tile index (e.g., geohash) based on the location of the geofence, e.g., its coordinates. Alternatively, the application or OS may use a lookup table or a map to find the tile and the tile index associated with the location of the geofence.

At 635, method 600 may include determining whether the tile index (e.g., geohash) already exists in the dictionary. The tile index (e.g., geohash) may exist in the dictionary due to a previous association of a geofence with that tile index (e.g., geohash). Alternatively, the application or OS may determine whether the tile or the tile index associated with the geofence exists in the dictionary. If the tile index (e.g., geohash) does not exist in the dictionary, the algorithm will follow the “No” path to perform the operation described at 640. If the tile index (e.g., geohash) exists in the dictionary, the algorithm will follow the “Yes” path to perform the operation described at 645.

At 640, method 600 may include adding the tile index (e.g., geohash) to the dictionary. Alternatively, the application or OS may add the tile index to the dictionary.

At 645, method 600 may include adding a geofence to the list of geofences in the dictionary associated with the tile index (e.g., geohash) or the tile index.

At 650, method 600 may include determining whether there are unselected geofences in the set that are not associated with a tile index (e.g., geohash). If there are unselected geofences that are not assigned to a tile index (e.g., geohash), the algorithm will follow the “Yes” path to perform the operation described at 625. If there are no unselected geofences, the algorithm will follow the “No” path to perform the operation described at 655. The operational flow/algorithmic structure 600 may include, at 655, terminating the algorithm.

### IV. Bounding Area

In areas with a high density of geofences, the application or OS may reduce computational complexity by monitoring mobile device location in a bounding area. The application or OS may select the size of the bounding area such that a limited number of geofences fall inside the bounding area. The application or OS may assume that the mobile device is inside the geofences that overlap with the bounding area. Once the mobile device exits the bounding area, the application or OS may create another bounding area based on the mobile device's location.

### A. General Descriptions of Bounding Area

The application or OS may be configured to monitor a maximum of K geofences (e.g., at least 20, 30, 40, 50, 60, 70, 80, 90, or 100). The bounding area allows the application or OS to allocate resources to monitor the highest number of geofences it is configured to monitor. The bounding area defines a geofence around the user device's location and monitors a subset, e.g., all or some, of geofences that overlap with the bounding area. At the time of creation, the bounding area may take the location of the user device as its center and select a radius between minimum and maximum radius values. For example, the bounding area may have a minimum radius of 400 meters and a maximum radius of 6500 meters.

In one embodiment, the application or OS may compute or set the radius of the bounding area to control the number of geofences overlapping with the bounding area. For example, if the bounding area with minimum radius value contains, e.g., overlaps with, less than K geofences, the application or OS may increase the radius until the bounding area contains K geofences.

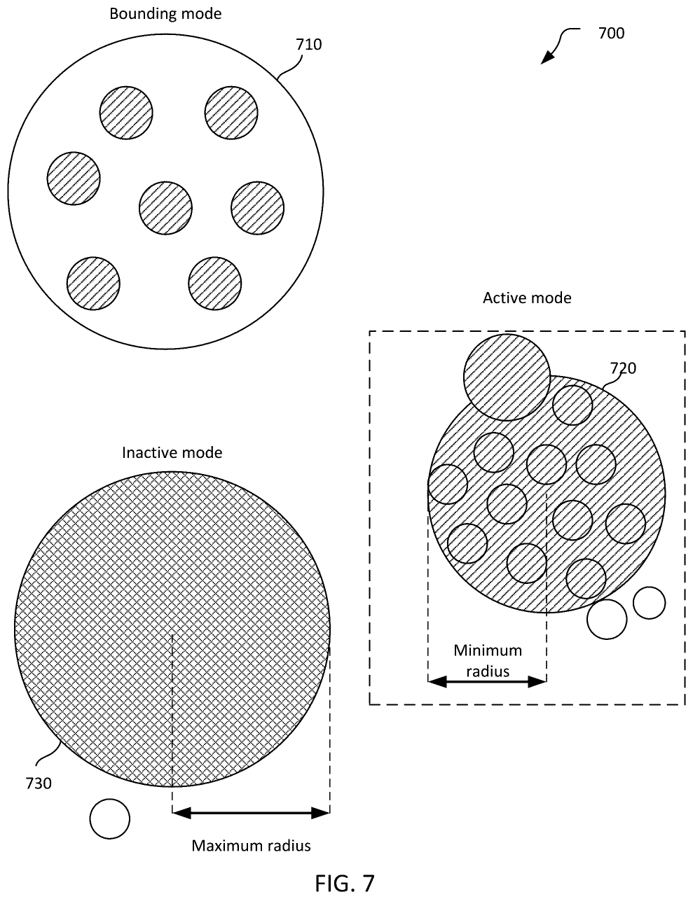

FIG. 7 illustrates a block diagram 700 of bounding area modes in accordance with some embodiments. Depending on the number of geofences in the bounding area, the bounding area may be associated with a bounding mode, an active mode, or an inactive mode.

For example, bounding area 710 may contain less than K geofences. In this case, the bounding area 710 is in a bounding mode. The application may choose the radius of the bounding area 710, up to the maximum radius value, to include up to K geofences in the bounding area. A bounding area with bounding mode may monitor all the geofences that overlap with the bounding area and trigger their corresponding actions accordingly. In one example, the maximum radius value of a bounding area may be 6500 meters.

In another example, a bounding area of 720 with a minimum radius may contain more than K geofences. The bounding area 720 with minimum radius and more than K geofences is in active mode. The application or OS may only monitor the active bounding area and not the individual geofences inside the active bounding area. Active bounding area 720 may include geofences that are completely inside the boundaries of the active bounding area 720 or geofences that overlap with the active bounding area 720. FIG. 7 also illustrates geofences that are not monitored and are outside the active bounding area 720. In one example, the minimum radius of the bounding area may be 400 meters. The application or OS assumes that the mobile device is in all the geofences included in an active bounding area, and therefore, the actions corresponding to all geofences included in the active bounding area are triggered. In one example, all geofences may have the same or similar actions.

In another example, bounding area 730 may contain no geofence. In this case, the application or OS may increase the radius of the bounding area 720, up to the maximum radius value to increase the number of geofences up to K geofences. However, if the bounding area 730 with maximum radius still does not contain any geofence, the bounding area 730 is assigned an inactive mode. The application or OS may set the radius to the maximum radius value and monitor any geofences in the bounding area, if any.

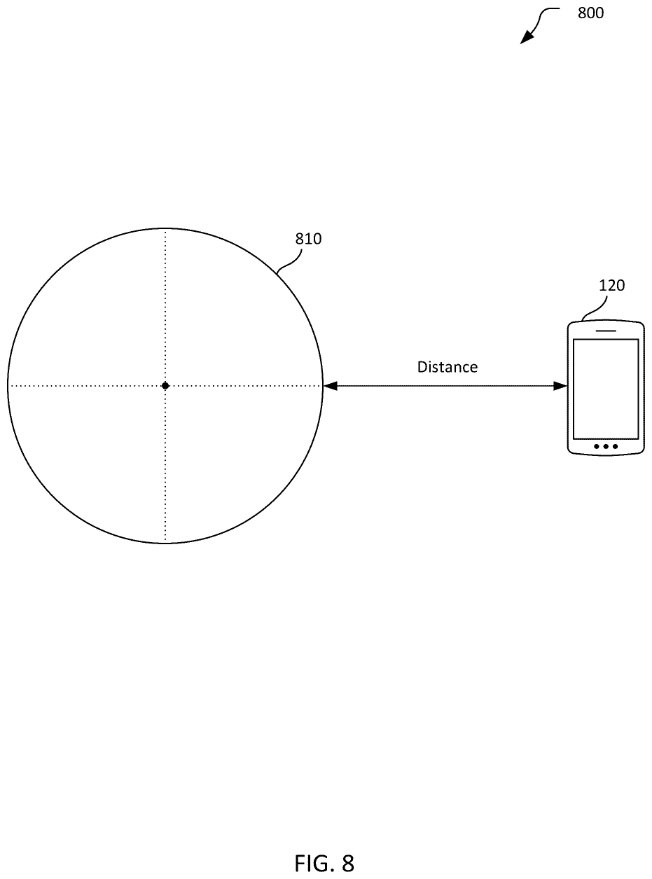

FIG. 8 illustrates a block diagram 800 for determining the distance between a user device and a geofence. The application or OS may need to dynamically determine the best K geofences to monitor to create a bounding area. The application or the OS determines the best geofences based on their distance to the user device.

The application or OS may need to order the geofences based on their distance to the user device 120. One option is to use the distance between the user device 120 and the center of the geofence, e.g., coordinates associated with the geofence. However, when calculating the distance, the radius and size of the geofence may not be considered. In another example, the application or OS may compute the distance between the user device 120 and the geofence 810 as the shortest distance between the user device 120 and the boundaries of the geofence 810. In one example, the distance between the user device 120 and the geofence 810 is the length of the line segment, with one end being the current location of the device and one end on the boundary of the geofence 810 and the extension of the line segment passes through the center of the geofence 810.

### B. Flowcharts

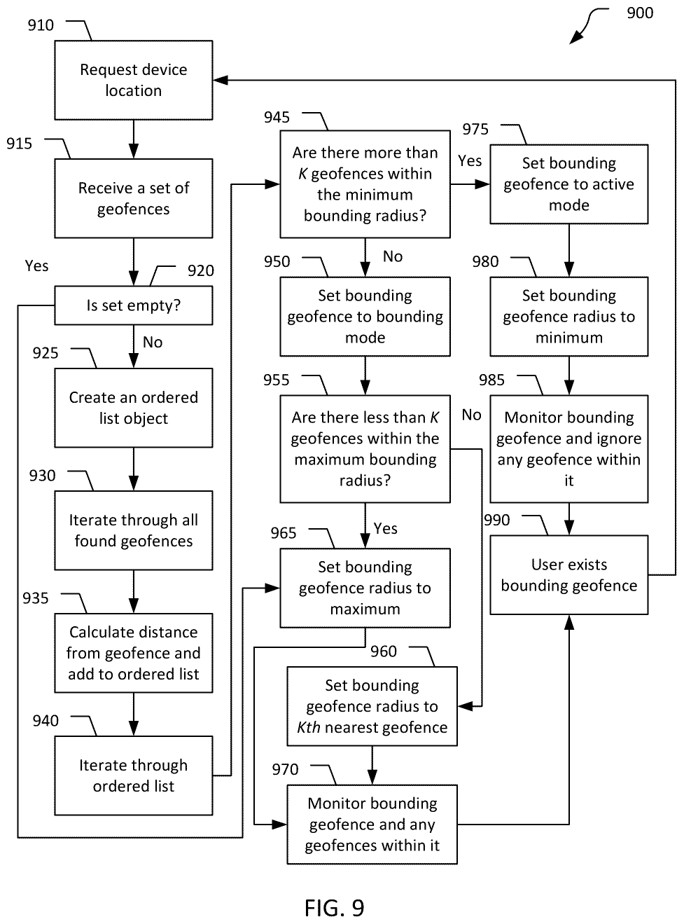

FIG. 9 illustrates method 900 for implementing bounding area in accordance with some embodiments. The operation flow/algorithmic structure 900 may be implemented by a mobile device, e.g., mobile device 1100, or the components therein, e.g., geofence module 1128, operating system 1122, or applications 1134.

The operational flow/algorithmic structure 900 may include, at 910, requesting device location. The application or OS may request from the other components in the device, e.g., GPS, to provide the device's location.

At 915, method 900 may include receiving a set of geofences. The application or OS may create the set of geofences and provide it to the bounding area algorithm by applying the geofence duplication detection flow and map tile filtering flow (e.g., geohashing) to the set of installed geofences. In one example, the received geofences may include the geofences in the tile (e.g., geohash) of the device's current location and the geofences in its immediate neighboring tiles (e.g., geohash). The application or OS may store the set of geofences in memory or storage on the device.

At 920, method 900 may include determining whether the set of geofences is empty. If the set of geofences is empty, the algorithm will continue on the “Yes” path to perform the operation described at 965. If the set of geofences is not empty, the algorithm will continue on the “No” path to perform the operation described at 925.

At 925, method 900 may include creating an ordered list object. In one example, the application or OS may create the ordered list object having the distance from the user's device to the geofence as the key and a list of geofences at that distance as the corresponding value.

At 930, method 900 may include iterating through all geofences in the set. In one example, the application or OS may assign an iterator to iterate through all the geofences in the set.

At 935, method 900 may include calculating the distance between the user's device's current location obtained in operation at 910 and each geofence in the set. The application or OS may use the procedure described above (FIG. 8) to compute the distance between the user's device's current location and each geofence in the set. Once the distance is computed, the application or OS adds it to the order list object created by the process described at 925.

At 940, method 900 may include iterating through the ordered list to find the best geofences for the application or OS to monitor. In one example, the application may assign an iterator to the order list to select entries of the ordered list.

At 945, method 900 may include determining whether more K geofences are within the minimum bounding radius from the user device's location. For example, the iterator assigned to the order list may select the smallest distance in the ordered list, check if the distance associated with the key value is smaller than the minimum radius, count the number of geofences associated with this key, and repeat until the distance value associated with the key is larger than the minimum distance. If there are more than K geofences within the minimum bounding radius, the algorithm will continue on the “Yes” path to perform the operation described at 975. If there are not more than K geofences within the minimum bounding radius, the algorithm will continue on the “No” path to perform the operation described at 950.

At 950, method 900 may include setting the bounding area mode to bounding mode.

At 955, method 900 may include determining whether there are less than K geofences within the maximum bounding radius. If there are less than K geofences within the maximum bounding radius, the algorithm will continue on the “Yes” path to perform the operation described at 965. If there are not more than K geofences within the maximum bounding radius, the algorithm will continue on the “No” path to perform the operation described at 960.

At 960, method 900 may include setting the bounding area radius to be the distance of the Kth nearest geofence obtained from the ordered list. By setting the bounding area radius to this value, there may be K−1 geofences in the bounding area.

At 965, method 900 may include setting the bounding area radius to the maximum. Although the number of geofences in the bounding area may be smaller than K, the maximum number of geofences is included in the bounding area by setting the geofence radius to the maximum value.

At 970, method 900 may include monitoring the bounding area and any geofences within it. In one example, monitoring may only include tracking whether the user device exits the boundaries of geofences or enters another geofence's area. Exiting can be monitored using a current location and comparing to a distance to a center point of the bounding area (bounding area). In one example, the monitoring may include notifying the application or OS when the user device's location enters or exits the area of a geofence. In one example, the monitoring may include determining whether entering or exiting a geofence and triggering an associated action accordingly.

At 975, method 900 may include setting the bounding area to active mode, e.g., when there are more than K geofences within the minimum bounding radius.

At 980, method 900 may include setting the bounding area radius to the minimum radius value. For other shapes of bounding areas, values other than a radius, e.g., a length of one or more sides of a box, can be used.

At 985, method 900 may include monitoring the bounding area and ignoring any geofence within it. The application or OS may consider that the device is inside all the geofences in the bounding area, even if the device is physically not inside one or more geofences inside the bounding area. When the user device exits the bounding area, the application or OS may consider the device to be outside of all of the geofences in the bounding area, even if the device is physically inside one or more of those geofences.

The bounding area may include the actions associated with all the geofences inside its boundaries and may trigger the appropriate actions as the user's device enters or exits a bounding area.

At 990, method 900 may include exiting the bounding area. The user device exits the boundaries of the bounding area. Once the algorithm detects that the user device's location is outside the boundaries of the bounding area, the algorithm may move to perform the operation described in 910 to request the device's location, form a new bounding area, and monitor the bounding area or the geofences in it.

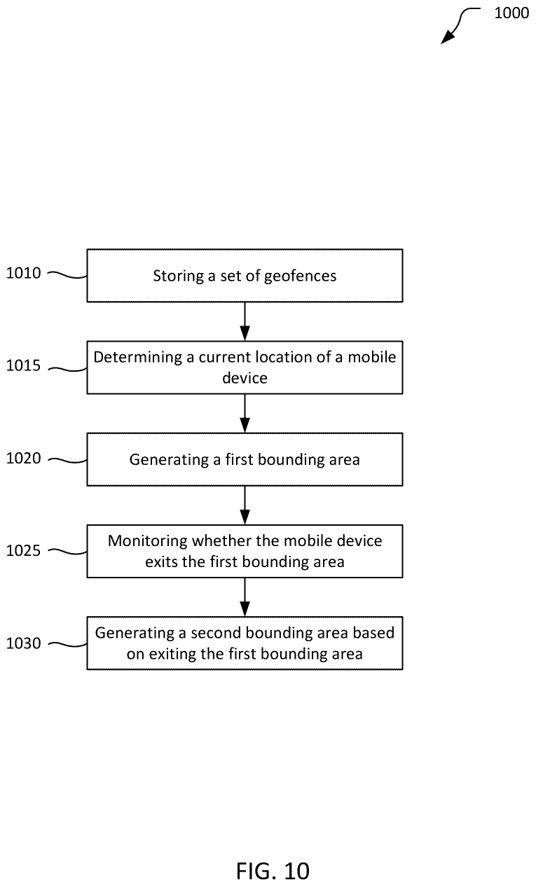

FIG. 10 illustrates method 1000 for implementing bounding area in accordance with some embodiments. The operation flow/algorithmic structure 1000 may be implemented by a mobile device, e.g., mobile device 1100, or the components therein, e.g., geofence module 1128, operating system 1122, or applications 1134.

At 1010, method 1000 may include storing a set of geofences. The application or OS may create the set of geofences and provide it to the bounding area algorithm by applying the geofence duplication detection flow and map tile filtering flow (e.g., geohashing) to the set of installed geofences. In one example, the received geofences may include the geofences in the tile (e.g., geohash) of the device's current location and the geofences in its immediate neighboring tiles. The application or OS may store the set of geofences in memory or storage on the device.

At 1015, method 1000 may include determining a mobile device's current location. The application or OS may request device location. The application or OS may request from other components in the device, e.g., GPS, to provide the device's location.

At 1020, method 1000 may include generating a first bounding area. The first bounding area may include no more than a specified number of the set of geofences. The algorithm may determine the radius of the bounding area based on the number of geofences inside the bounding area.

The bounding area may have a radius. The radius of a bounding area may have a value between a minimum value and a maximum value. Based on the number of geofences included in the bounding area or the radius of the bounding area, the bounding area may be in bounding, active, or inactive mode.

A bounding area with no more than the specified number of geofences is in bounding mode. A bounding area with a radius having a minimum value and more than the specified number of geofences is in active mode. A bounding area with a radius having a maximum value and no geofences is in inactive mode.

At 1025, method 1000 may include monitoring whether the mobile device exits the first bounding area. The application or OS may monitor the geofences in a bounding area in bounding mode and trigger their actions accordingly. The application or OS may consider that all geofences in a bounding area with active mode are triggered.

At 1030, method 1000 may include generating a second bounding area based on exiting the first bounding area. When the application or OS determines that the mobile device exits the bounding area, it may request the new location of the mobile device and generate the second bounding area around the new location of the mobile device such that the bounding area has a radius with minimum value or with no more than the specified number of geofences.

In some embodiments, instead of ensuring that the bounding area has no more than a specified number of the set of geofences, a bounding area can be selected based on other criteria. For example, a default bounding area can be selected. Or a bounding area can be selected based on population, building, or business density, e.g., smaller bounding areas in a city relative to rural areas. Then, once the bounding area is selected, only geofences within the bounding area may be selected for monitoring. In one sense, when map tile filtering is used, the bounding area can be defined by the neighboring map tiles. The geofences that lie at least partially within the current map tile (i.e., where the mobile device is located) and any of the neighboring map tiles can only be monitored or a smaller or later bounding area can be used. A reevaluation of the bounding area can be determined when a mobile device exits a bound area.

### V. Example Device

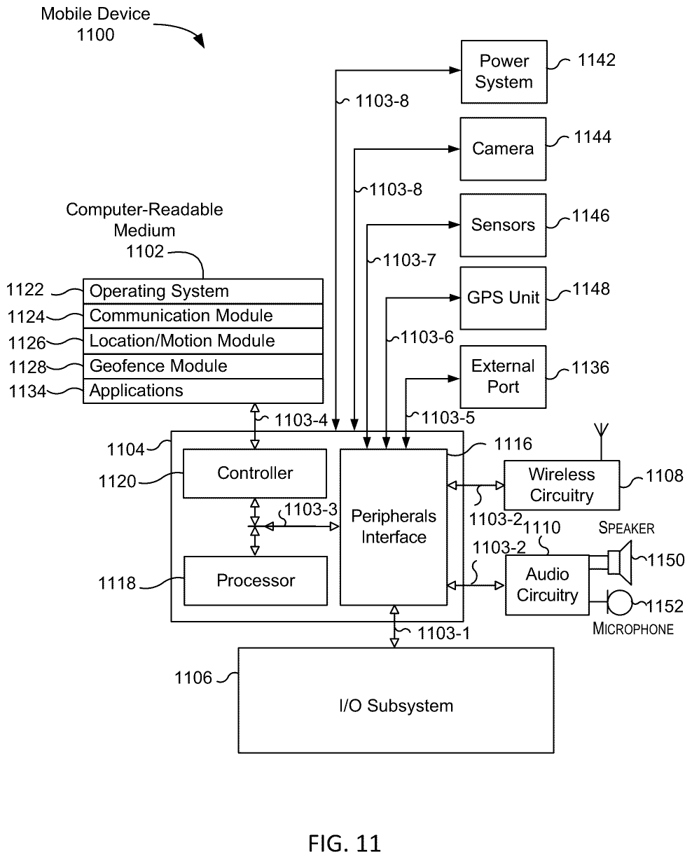

FIG. 11 is a block diagram of an example electronic device 1100. Device 1100 generally includes computer-readable medium 1102, a processing system 1104, an Input/Output (I/O) subsystem 1106, wireless circuitry 1108, and audio circuitry 1110 including speaker 1152 and microphone 1150. These components may be coupled by one or more communication buses or signal lines 1103. Device 1100 can be any portable electronic device, including a handheld computer, a tablet computer, a mobile phone, laptop computer, tablet device, media player, personal digital assistant (PDA), a key fob, a car key, an access card, a multi-function device, a mobile phone, a portable gaming device, a headset, or the like, including a combination of two or more of these items.

It should be apparent that the architecture shown in FIG. 11 is only one example of an architecture for device 1100, and that device 1100 can have more or fewer components than shown, or a different configuration of components. The various components shown in FIG. 11 can be implemented in hardware, software, or a combination of both hardware and software, including one or more signal processing and/or application specific integrated circuits.

Wireless circuitry 1108 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1108 can use various protocols, e.g., as described herein. In various embodiments, wireless circuitry 1108 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WiFi (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 1108 is coupled to processing system 1104 via peripherals interface 1116. Peripherals interface 1116 can include conventional components for establishing and maintaining communication between peripherals and processing system 1104. Voice and data information received by wireless circuitry 1108 (e.g., in speech recognition or voice command applications) is sent to one or more processors 1118 via peripherals interface 1116. One or more processors 1118 are configurable to process various data formats for one or more application programs 1134 stored on medium 1102.

Peripherals interface 1116 couple the input and output peripherals of device 1100 to the one or more processors 1118 and computer-readable medium 1102. One or more processors 1118 communicate with computer-readable medium 1102 via a controller 1120. Computer-readable medium 1102 can be any device or medium that can store code and/or data for use by one or more processors 1118. Computer-readable medium 1102 can include a memory hierarchy, including cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). In some embodiments, peripherals interface 1116, one or more processors 1118, and controller 1120 can be implemented on a single chip, such as processing system 1104. In some other embodiments, they can be implemented on separate chips.

Processor(s) 1118 can include hardware and/or software elements that perform one or more processing functions, such as mathematical operations, logical operations, data manipulation operations, data transfer operations, controlling the reception of user input, controlling output of information to users, or the like. Processor(s) 1118 can be embodied as one or more hardware processors, microprocessors, microcontrollers, field programmable gate arrays (FPGAs), application-specified integrated circuits (ASICs), or the like.

Device 1100 also includes a power system 1142 for powering the various hardware components. Power system 1142 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1100 includes a camera 1144. In some embodiments, device 1100 includes sensors 1146. Sensors can include accelerometers, compass, gyrometer, pressure sensors, audio sensors, light sensors, barometers, and the like. Sensors 1146 can be used to sense location aspects, such as auditory or light signatures of a location.

In some embodiments, device 1100 can include a GPS receiver, sometimes referred to as a GPS unit 1148. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1118 run various software components stored in medium 1102 to perform various functions for device 1100. In some embodiments, the software components include an operating system 1122, a communication module 1124 (or set of instructions), a location module 1126 (or set of instructions), a geofence module 1128 that is used as part of geofence monitoring operation described herein, and other application programs 1134 (or set of instructions).

Operating system 1122 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1124 facilitates communication with other devices over one or more external ports 1136 or via wireless circuitry 1108 and includes various software components for handling data received from wireless circuitry 1108 and/or external port 1136. External port 1136 (e.g., USB, FireWire, Lightning connector, 60-pin connector, etc.) is adapted for coupling directly to other devices or indirectly over a network (e.g., the Internet, wireless LAN, etc.).

Location/motion module 1126 can assist in determining the current position (e.g., coordinates or other geographic location identifiers) and motion of device 1100. Modern positioning systems include satellite based positioning systems, such as Global Positioning System (GPS), cellular network positioning based on “cell IDs,” and WiFi positioning technology based on a WiFi networks. GPS also relies on the visibility of multiple satellites to determine a position estimate, which may not be visible (or have weak signals) indoors or in “urban canyons.” In some embodiments, location/motion module 1126 receives data from GPS unit 1148 and analyzes the signals to determine the current position of the mobile device. In some embodiments, location/motion module 1126 can determine a current location using WiFi or cellular location technology. For example, the location of the mobile device can be estimated using knowledge of nearby cell sites and/or WiFi access points with knowledge also of their locations. Information identifying the WiFi or cellular transmitter is received at wireless circuitry 1108 and is passed to location/motion module 1126. In some embodiments, the location module receives the one or more transmitter IDs. In some embodiments, a sequence of transmitter IDs can be compared with a reference database (e.g., Cell ID database, WiFi reference database) that maps or correlates the transmitter IDs to position coordinates of corresponding transmitters, and computes estimated position coordinates for device 1100 based on the position coordinates of the corresponding transmitters. Regardless of the specific location technology used, location/motion module 1126 receives information from which a location fix can be derived, interprets that information, and returns location information, such as geographic coordinates, latitude/longitude, or other location fix data

Geofence module 1128 monitor geofences installed by the application or OS. Geofence module 1128 may perform geofence duplication detection flow, map tile filtering flow (e.g., geohashing), and creating and tracking bounding areas consistent with embodiments described herein.

The one or more applications 1134 on device 1100 can include any applications installed on the device 1100, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1106 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1106 can include a display and user input devices such as a keyboard, mouse, and/or trackpad. In some embodiments, I/O subsystem 1106 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1102) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1106 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1100 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

For the purposes of the present document, the phrase “A or B” means (A), (B), or (A and B), and the phrase “based on A” means “based at least in part on A,” for example, it could be “based solely on A,” or it could be “based in part on A.”

What is claimed is:

1. A method comprising:
storing a set of geofences;
determining a current location of a mobile device;
generating a first bounding area around the current location, wherein the first bounding area includes no more than a specified number of geofences of the set of geofences or has a radius having a minimum value;
monitoring whether the mobile device exits the first bounding area;
determining that the mobile device exits the first bounding area; and
responsive to exiting the first bounding area, generating a second bounding area, and wherein the second bounding area includes no more than the specified number of geofences of the set of geofences.

2. The method of claim 1, further comprising:
determining a mode of the first bounding area based on a radius value of the first bounding area and a number of geofences of the set of geofences included in the first bounding area.

3. The method of claim 2, wherein the first bounding area includes more than the specified number of geofences of the set of geofences and the radius value of the first bounding area is the minimum value, said determining a mode of the first bounding area is determining the mode of the first bounding area to be an active mode, and the method further comprises:
monitoring the first bounding area; and
ignoring geofences of the set of geofences included in the first bounding area.

4. The method of claim 2, wherein the first bounding area includes less than the specified number of geofences of the set of geofences and the radius value of the first bounding area is a minimum value, said determining a mode of the first bounding area is determining the mode of the first bounding area to be a bounding mode, and the method further comprises:
monitoring the first bounding area and geofences of the set of geofences included in the first bounding area.

5. The method of claim 2, wherein the first bounding area includes no geofences of the set of geofences and the radius value of the first bounding area is a maximum value, said determining a mode of the first bounding area is determining the mode of the first bounding area to be an inactive mode, and the method further comprises:
monitoring the first bounding area and the geofences of the set of geofences included in the first bounding area.

6. The method of claim 1, further comprising:
ordering the set of geofences based on a distance from the current location, wherein the first bounding area has a radius that equals the distance to an Nth furthest geofence, where N is a specified number.

7. The method of claim 1, further comprising:
determining that a first geofence overlaps by at least a specified percentage with a second geofence; and
generating a third geofence that encompasses the first geofence and the second geofence, wherein the set of geofences includes the third geofence.

8. The method of claim 1, wherein each of the set of geofences lies within a respective map tile of a plurality of map tiles and is stored in association with the respective map tile, and wherein the current location is within a first map tile, the method further comprising:
identifying a plurality of geofences that are within the first map tile or one or more neighboring map tiles, wherein the plurality of geofences include a first subset of geofences.

9. The method of claim 8, wherein the set of geofences are stored in association with hashes of the plurality of map tiles, and wherein the hashes indicate a spatial relationship with neighboring map tiles.

10. The method of claim 1, further comprising:
triggering a first subset of the set of geofences that are within the first bounding area before the mobile device crosses the first bounding box.

11. A non-transitory computer-readable medium storing computer-executable instructions that, when executed by one or more processors of a user device, cause the one or more processors to:
store a set of geofences;
determine a current location of a mobile device;
generate a first bounding area around the current location, wherein the first bounding area includes no more than a specified number of geofences of the set of geofences or has a radius having a minimum value;
monitor whether the mobile device exits the first bounding area;
determine that the mobile device exits the first bounding area; and
responsive to exiting the first bounding area, generate a second bounding area, and wherein the second bounding area includes no more than the specified number of geofences of the set of geofences.

12. The non-transitory computer-readable medium of claim 11, wherein the instructions, when executed by one or more processors of the user device, cause the one or more processors further to:
determine a mode of the first bounding area based on a radius value of the first bounding area and a number of geofences of the set of geofences included in the first bounding area.

13. The non-transitory computer-readable medium of claim 11, wherein the instructions, when executed by one or more processors of the user device, cause the one or more processors further to:
order the set of geofences based on a distance from the current location, wherein the first bounding area has a radius that equals the distance to an Nth furthest geofence, where N is a specified number.

14. The non-transitory computer-readable medium of claim 11, wherein the instructions, when executed by one or more processors of the user device, cause the one or more processors further to:
determine that a first geofence overlaps by at least a specified percentage with a second geofence; and
generate a third geofence that encompasses the first geofence and the second geofence, wherein the set of geofences includes the third geofence.

15. The non-transitory computer-readable medium of claim 11, wherein each of the set of geofences lies within a respective map tile of a plurality of map tiles and is stored in association with the respective map tile, and wherein the current location is within a first map tile, and the instructions, when executed by one or more processors of the user device, cause the one or more processors further to:
identify a plurality of geofences that are within the first map tile or one or more neighboring map tiles, wherein the plurality of geofences include a first subset of geofences.

16. A user device comprising:
a memory configured to store computer-executable instructions; and
one or more processors configured to:
store a set of geofences;
determine a current location of a mobile device;
generate a first bounding area around the current location, wherein the first bounding area includes no more than a specified number of geofences of the set of geofences or has a radius having a minimum value;
monitor whether the mobile device exits the first bounding area;
determine that the mobile device exits the first bounding area; and
responsive to exiting the first bounding area, generate a second bounding area, and wherein the second bounding area includes no more than the specified number of geofences of the set of geofences.

17. The user device of claim 16, wherein the one or more processors configured further to:
determine a mode of the first bounding area based on a radius value of the first bounding area and a number of geofences of the set of geofences included in the first bounding area.

18. The user device of claim 16, wherein the one or more processors configured further to:
order the set of geofences based on a distance from the current location, wherein the first bounding area has a radius that equals the distance to an Nth furthest geofence, where N is a specified number.

19. The user device of claim 16, wherein the one or more processors configured further to:
determine that a first geofence overlaps by at least a specified percentage with a second geofence; and
generate a third geofence that encompasses the first geofence and the second geofence, wherein the set of geofences includes the third geofence.

20. The user device of claim 16, wherein each of the set of geofences lies within a respective map tile of a plurality of map tiles and is stored in association with the respective map tile, and wherein the current location is within a first map tile, and the one or more processors configured further to:
identify a plurality of geofences that are within the first map tile or one or more neighboring map tiles, wherein the plurality of geofences include a first subset of geofences.
